(19) United States
(12) Patent Application Publication
(10) Pub. No.: US 2010/0313011 A1
(43) Pub. Date: Dec. 9, 2010

(54) Identity Data Management in a High Availability Network

(76) Inventor: Thomas M. Laffey, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/481,533

(22) Filed: Jun. 9, 2009

(51) Int. Cl. H04L 9/32

(52) U.S. Cl. 713/155

(57) ABSTRACT

The present invention is a network device in a high availability network that includes a a removable first identity data storage module that includes a TPM and that is associated with a first memory storage device, wherein identity data unique to the network device is stored in the first memory storage device. The removable first identity data storage module is installed in the network device the first time the network device is powered up. The network device also includes a removable first management module, that includes a TPM and a central processing unit. The first management module is installed in the network device the first time the network device is powered up. When the network device is powered up for the first time, identity data from the first identity data storage module is migrated to the TPM of the first removable management module.

### BACKGROUND

A Trusted Platform Module (TPM) provides secure storage for cryptographic identity information such as signing keys. Should the TPM fail or become inaccessible due to some other hardware failure, however, the cryptographic information becomes unavailable or may be lost. In a high-availability system, hardware and data is often made redundant to prevent losing access to the data in the event of a failure. Merely copying the data stored by the TPM is not possible as the TPM is designed to prevent disclosure of the cryptographic identity information (keys) while still allowing use of the keys to perform cryptographic operations within the TPM.

Some TPM solutions, such as those providing cryptographic key backup for a personal computer (PC), will “migrate” the cryptographic information (i.e. keys) from the personal computer's TPM to a TPM on a particular server. This provides assurance against key loss, but once the PC hardware is not available, the PC user must cause the cryptographic information stored on the server to be transferred (or migrated) to a new PC's TPM, before the cryptographic information is available for use.

A high availability system which provides information redundancy without intervention by a individual network administator is needed.

### BRIEF DESCRIPTION OF THE DRAWINGS

The figures depict implementations/embodiments of the invention and not the invention itself. Some embodiments of the invention are described, by way of example, with respect to the following Figures:

FIG. 1 shows a block diagram of a network chassis in a high availability network according to one embodiment of the invention.

FIG. 2 shows the key hierarchy structure of a management module TPM's according to one embodiment of the present invention.

FIG. 3 shows the key hierarchy structure of an identity data storage module's TPM according to one embodiment of the present invention.

FIGS. 4A and 4B show a flowchart of a method for sharing identity information between identity data storage and management modules in one embodiment of the present invention.

### DETAILED DESCRIPTION

The present invention is a network device 100 in a high, availability network, comprising: a removable first identity data storage module 120a, the removable first identity storage module including a TPM 122a and being associated with a first memory storage device 124a, wherein identity data unique to the network device is stored, in the first memory storage device, wherein the removable first identity data storage module is installed in the network device 100 the first time the network device is powered up, wherein the removable first identity data storage module is capable of communicating with a removable first management module, the removable first management module 130a associated with a TPM and a central processing unit 134a, wherein the first management module is installed in the network device the first time the network device is powered up, whereupon when the first network device is powered up for the first time, identity data from the first identity data storage module is migrated to the TPM 132a of the first removable management module 130a.

An advantage of the present invention is that at no time is the identity data open for theft or modification. Also, due to the features of the TPM, a remote individual or software application can be assured that the identity data is stored within a TPM, thereby providing assurance that a cryptographic signature provided using the identity data is not forged. Further, although migration of identity information is allowed within the chassis, in the present invention there are restrictions which prevent identity information from either (1) being copied to another chassis or (2) lost due to failure or board removal. In other words, the present invention provides redundant—even concurrent—access to the identity information without risk of copying it between one chassis and another.

When compared to the implementation described in the Background of the Invention where a remote server is used to backup identity data, the present invention provides redundancy such that the system always has the required identity information available. Further, the described invention further prevents the cryptographic data from being used outside of the device trusted to maintain the identity data securely while still retaining the network device's ability to use it for normal operation.

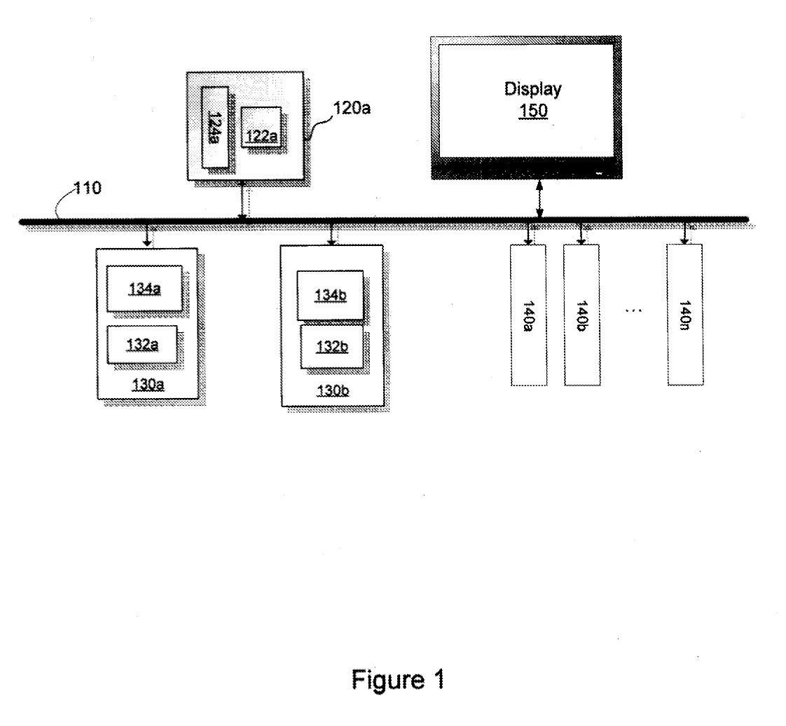

Referring to FIG. 1 shows a switch backplane. The switch backplane 100 includes a bus 110. Connected to the backplane bus 110 are an identity storage module 120a and a first and second management module 130a and 130b. Further connected to the backplane 100 are a plurality of Interface (I/F) Modules 140a, 140b . . . 140n. Referring to FIG. 1, in the preferred embodiment the first and second management modules 130a, 130b includes both a TPM 132a, 132b and a CPU 134a, 134b. In the preferred embodiment, the first identity data storage module 120a includes a TPM 122a but does not include a CPU.

Electrically coupled to both first and second management modules is the Chassis Front Panel Display (CFD) 150. The CFD contains a persistent storage memory device (for example, EEPROM or Flash) which contains chassis information such as serial number, base MAC ID, etc. The CFD is not intended to be removed from the chassis, but the present invention allows one hut not both of the CFD and identity data storage module to be absent or defective when the system boots and still maintain correct operation. (After booting, this data is cached on the Management Module(s) present.)

There is a Trusted Platform Module (TPM) (122a, 132a, 132b) on each management module and on the identity data storage module 120. A TPM is a commercially available device that performs some cryptographic operations using cryptographic key data that is securely stored internal to the TPM device. The TPM is a security chip that has intrusion prevention features. In the preferred embodiment, to provide the lowest-cost solution, the TPM used is primarily intended for PC use, and is designed to allow a PC user to provide an encrypted electronic signature.

Preferably, the identity data storage module 120a includes at least one TPM module 122a and a first memory storage device 124a. In the preferred embodiment, the first memory storage device 124a is an EEPROM. The EEPROM is where the initial identity information is stored. However, any non-volatile memory storage device capable of storing chassis identification information by the manufacturer before shipment of the chassis components to the end Network Owner, may be used. For example, a memory storage device might be a ROM (PROM, EPROM, EEROM, EEPROM) or a flash memory device.

Typically from the factory we have a chassis 100 that is shipped oat that includes an identity data storage module 120a that has a chassis certificate and it keys associated with that chassis certificate. Typically, the chassis is shipped from the factory without a management module 130. In our system, until the management module is purchased and installed by the customer, the redundancy features of the present invention are not available. Before the management module 130 is installed, it has no chassis identification information. The management module gets the chassis identification information from the chassis front panel display and from the identity data storage module. Chassis and network device or switch are sometimes used interchangeably in this application. Although chassis is thought of as the mechanical surrounding the network device, the term is sometimes used instead of the term “network device.”

In the preferred embodiment, the initial identity information for the chassis or switch 100 is always stored in the identity data storage module 120. Upon initialization or booting up of the system for the first time (e.g., just after insertion of the first management module 130a), at least a first identity data storage module 120a and a first management module 130a mast be present in the system. The identity information (OEM Identity Data) from the first identity data storage module is then migrated to at least one management module. After initialization (the first identity data storage module has shared the identity information with the at least the first management module), the first identity data storage card or one of the two management modules may be removed from the system. What is critical to preservation of identity information on the chassis is that one of the modules that has a TPM with the identity information either originally installed on the device (the case of the first identity data storage module) or shared identity information (the case of the first management module) is present in the system.

The term “identity data” may be used to encompass the terms OEM Identity Data or Network Owner Data as used throughout this application. In both cases the term identity data is used to describe data unique to the network device that is stored by the TPMs of the network device.

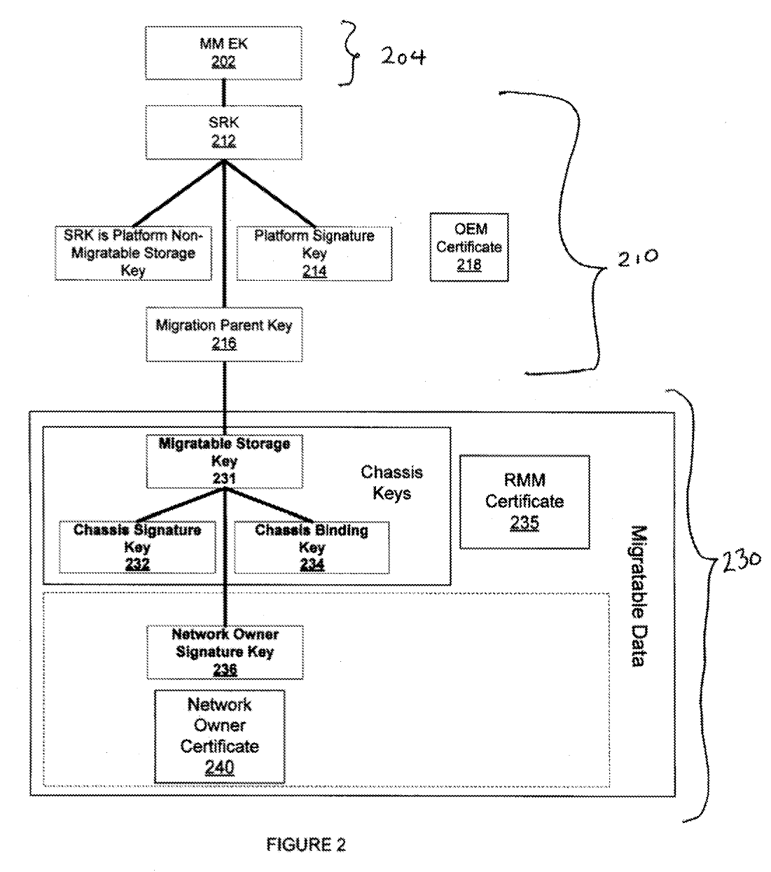

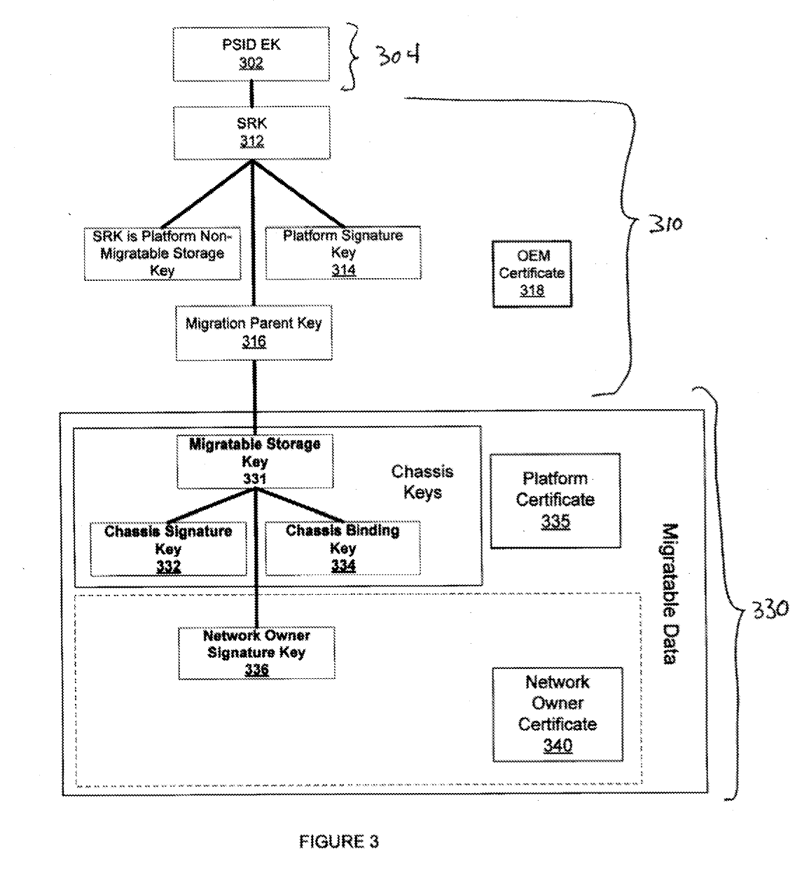

“OEM Identity Data” is installed by the equipment manufacturer and typically specifies chassis-specific data including the manufacturer, model number, serial number, base MAC ID, etc. The certificate corresponding to OEM identity Data includes the public key associated with the Chassis Signature Key. “Network Owner Data” is the identity data installed as the system is deployed into the owner's network by a network administrator. The Network Owner Data is determined by the Network Owner and is identity data that can provide whatever information the Network Owner desires. For example, in some cases the network administrator may choose not to change the content of the Network Owner Data from the OEM Identity Data (specifies chassis-specific data including the manufacturer, model number, serial number, base MAC ID, etc). Alternatively, the network administrator may choose to add or change the identity data from the original OEM Identity Data (for example, it may specify that network device XYZ is in Houston, has Part Number ABC, located in Building 4, 5^{th} floor). In other words, the OEM Identity Data may have completely different content (no overlap) from the Network Owner Data, may have some overlapping content, or may have identical content. In all cases, however, the Network Owner Data must include information that is unique to the chassis. The Network Owner Data is different from the OEM Identity Data in that the Network. Owner uses his own Certificate Authority to sign the certificates. This is described in more detail with reference to FIGS. 2 and 3.

There is a temporal component to the term identity data. The first time the system boots up, the identity data is always the OEM Identity Data. After the network administrator has configured the Network Owner Data, the identity data is the Network Owner Data. As previously described, the content of this data can be overlapping or non-overlapping.

Within the network device, a hierarchy of cryptographic keys will be maintained using the multiple Trusted Platform Module's (TPM's) shown in the FIGS. 1-3. The majority of the keys provided by the TPM are asymetrical key pairs comprised of a public key and a private key. The public key is public and may be widely distributed and shared. In contrast, the private key is kept secret and not shared. Data encrypted by the public key can be only decrypted by the private key.

Within the switch shown in FIG. 1, a hierarchy of cryptographic keys will be maintained using the multiple Trusted Platform Modules (TPMs) shown in FIGS. 2 and 3. FIG. 2 shows an example key hierarchy structure of a management module's TPM according to one embodiment of the invention. FIG. 3 shows an example key hierarchy structure of an identity data storage module's TPM according to one embodiment of the invention.

FIGS. 2 and 3 both show an example key hierarchy. The actual created hierarchy may be different than the examples shown provided that the key hierarchy allows migrating the Network Owner Data to another TPM within the chassis. The identity data storage card's TPM stores the private key and it's EPROM stores the public key and certificate. The private key, public key and certificate are migrated to the management module.

FIG. 2 shows the hierarchical key structure 200 of a management module's TPM according to one embodiment of the invention. Referring to FIG. 2, the first level of the hierarchy 204 includes the MMEK (Management Module Endorsement Key) 202. The MMEK 202 is installed by the manufacturer of the TPM to allow remote proof using cryptographic procedures that the TPM is from the specified manufacturer. This provides assurance that child keys (those lower in the key hierarchy) are under control of a TPM and not merely software.

Referring to FIG. 2, the second level of the hierarchy 210 includes the platform keys. The platform keys and OEM certificate 218 are installed at manufacture by the switch manufacturer or whomever the switch manufacturer designates with this task. The Storage Root Key (SRK) 212 is child of the MMEK. The SRK 212 is specific to the chassis, with access (use of) the SRK requiring chassis identifying information and is non-migratable.

The modules know they are on the same chassis and that sharing of identity information is permitted via the TPM's SRK 212. The TPM's SRK is a platform key installed at manufacture that is not transferable. The TPM's SRK has a password that includes chassis identifying information that is unique. In other words, built into the key hierarchy of the TPM's of both the identity data storage module 120 and management modules 130 is keying information (password information) on which chassis this key is to be used on. Because the manufacturer of the chassis knows the chassis unique identifying information, it knows what information to put on the SRK of the module to ensure that the modules in the chassis can exchange identity information. This makes it easy, even if modules are purchased and installed into the chassis at a later date than the original date of chassis manufacture, to add modules into the system. Also, this ensures that modules produced by another manufacturer do not work within the chassis, thus preventing counterfeiting.

Referring to FIG. 2, the Platform Signature Key 214 and Migration Parent Key 216 are derived from the SRK 212 which is the parent of these keys. The Platform Signature Key 216 allows verification of the module manufacturer. Since the TPM 132 has minimum internal storage, rather than store every key in the TPM, which would quickly fill the limited storage, the TPM stores only a few keys in its internal memory. The TPM keys which are not stored in the TPM are either derived from or encrypted by a key in TPM internal memory. The Migration Parent Key 216 is a migratable key and is used as the parent of the keys generated at the third level of the hierarchy. A platform certificate (the OEM Certificate) 218 is generated during the manufacturing process and is stored in flash memory on the management module. The platform certificate does not change for the life of the network device and is not transferable.

The OEM identity Data is used to represent the physical details of the device remotely and allows a remote network administrator to verify that what they are configuring the correct and authentic network device. Once they trust that the network device is as represented, they may install their own identity the Network Owner Data. The Network Owner Data allows one device to extend trust to another device that is also configured with an identity installed by the same Owner. Identity authentication may then be used to extend authorization for some level of network access.

Since the network device supports redundant hardware to provide high availability, the OEM Identity Data and the Network Owner Data must remain available, but must not be transferable to another network device. Since the OEM identity Data is tied to unique aspects of the chassis, this chassis-specific data is used in storing the OEM Identity Data and Network Owner Data in the TPM such that they are tied to a specific chassis. The security features of the TPM are used to prevent unauthorized disclosure or duplication of the private keys outside of the platform group.

Referring to FIG. 2, the third level of the hierarchy 230 includes a Migratable Storage Key 231 that is used in the generation of a Chassis Signature Key 232, a Chassis Binding Key 234 and a Network Owner Signature Key 236. Also, in the third level of the hierarchy a Network Owner Certificate 240 is also generated. Optionally, a Network Owner Binding Key 238 (not shown) may also be generated. The primary storage for the Network Owner Data (Network Owner Keys (236,238) plus the Network Owner Certificate 240) is on the identity data storage card. However, the Network Owner Data is also cached on the management module 130 by migrating it to the management module's TPM when the management module is initialized (i.e., when the network device is booted).

The caching process works as follows: using standard TPM operations, the identity data (Network Owner Cryptographic Data) is encrypted by the identity data storage module's TPM using a public cryptographic encryption key corresponding to a private key known only to the management module's TPM. The encrypted Network Owner Data is then stored or cached in the management module's local file system along with the User Network Certificate in order to allow the Network Owner Data to be present in the event that the identity data storage module becomes unavailable. When the management module is operational, these Network Owner Keys are also migrated into the management module's TPM for normal use.

Migration is part of the TPM feature set. In the present invention, we limit migration of the identity data to modules within the chassis. To confirm that a module is part of the chassis group, the MAC ID and serial number of the module is checked to verify that it is associated with the chassis. Alternatively, the keys themselves can be checked to confirm that the passwords match. Keys are unique to a particular chassis. Since passwords are different from one chassis to the next, if the passwords do not match then identity data will not be migrated. Further, if the system is migrating identity information to two different TPMs (for example an identity data storage module migrating to a first management module and a second management module within the chassis), the switch needs to do two different migrations with two different sets of keys.

TPM's are designed to require a “password” to allow use of any key. PCR's (Platform Configuration Registers) are a TPM feature that allows control of access to keys depending on the values held dynamically by the TPM.

As described above, the Network Owner Keys (Network Owner Signature key+optionally Network Owner Binding Key) are encrypted by the TPM on the identity data storage module and sent to the management module when migrating the Network Owner Keys from the identity data storage module to the management module. In one embodiment, the encryption key password is a hash of the MAC ID, model information and serial number of the network device. The encrypted data artifact that is transferred across the backplane is referred to here as a “blob” or alternatively as a “migration blob.” Typically, the migration blob is stored on the management module's local file system. The blob is then loaded into the management modules local TPM when needed. In order to ensure that the Network Owner Keys are only usable on the chassis (network device) for which they are intended, additional protection beyond the key access password may be provided. Either: (1) the cached “migration blob” on the management module is encrypted again using data from the chassis (network device) or alternatively (2) the TPM's are configured to allow the use of the Network Owner Keys only with certain Platform Configuration Register (PCR) configurations.

FIG. 3 shows the key hierarchy structure of an identity data storage module according to one embodiment of the present invention. Referring to FIG. 3, the first level of the hierarchy 304 includes the PSID EK (Power Supply and Identification module Endorsement Key) 302. As with the MM EK 202, the PSID EK 302 is installed in the TPM by the TPM Manufacturer.

Referring to FIG. 3, the second level of the hierarchy 310 includes the platform keys. The platform keys are installed at manufacture by the switch manufacturer or whomever the switch manufacturer designates with this task. The Storage Root Key (SRK) 312 is child of the PSID EK 302. The SRK 312 is specific to the chassis, includes chassis identifying information and is non-migratable. The Migration Parent Key 316 is derived from the SRK 312 which is the parent of this keys. The Migration Parent Key 316 is a migratable key and is used in the generation of the keys at the third level of the hierarchy.

Referring to FIG. 3, the third level of the hierarchy 330 includes a Migratable Storage Key 331 that is used in the generation of a Chassis Signature Key 332, a Chassis Binding Key 334 and a Network Owner Signature Key 336. Also, in the third level of the hierarchy a Network Owner Certificate 340 is also generated and optionally, a Network Owner Binding Key 338 (not shown) may also be generated.

Referring to FIG. 3, the OEM Platform Certificate 335 is stored in an EEPROM of the identity data storage module 120 at the time of manufacture. The OEM Platform Certificate 335 does not change for the life of the network device and it is non-transferable. Network Owner Keys are stored on the identity data storage module's EEPROM and are migrated to the management module when the device is initialized. This provides the required level of redundancy. Operations involving the Network Owner Data are performed on the management module using the identity information (Network Owner Cryptographic Data) that has been migrated from the identity data storage module. Thus the identity data storage module's TPM creates the Network Owner Keys when the Network Owner Certificate is created. After the Network Owner Data is created, the identity data storage TPM serves only to control the migration of these keys to the management module's TPM.

The network device in this design is constructed using multiple modules or cards that are removable and can be plugged in or unplugged as needed, whether or not the device is running. In the described system, it is assumed that only one module (in the group of management modules and identity modules) will be removed or will fail at one time before a Network Owner replaces or re-installs a new module.

The management modules 130 and identity data storage modules 120 are designed to be removable and insertable into a different chassis or network device. For example, the management module and the identity data storage modules can be moved from one chassis to another. For example, a management module from the switch chassis B can be transferred into an identical (same model, but different serial number) chassis A.

However, the identity information from one switch or network device should not be transferable to another chassis or network device. A management module running in a second chassis B containing Network Owner Data that was cached when the management module card was installed and operating in the first chassis A will not have the chassis information required to decrypt the previously cached Network Owner Data. Since the previously cached Network Owner Data is not recognized, it is deleted from the local file system. In other words. Network Owner Data from Chassis B is deleted when the management module is moved and inserted into chassis A. The management module software then performs a new migration (caching) operation to obtain the Network Owner Cryptographic Data.

The cryptographic information must be tied to the network switch such that any portion (or module) of the switch that contains or includes a TPM will not provide use of that cryptographic information when installed in some other network switch or some other computing device. The problems solved by the present invention are therefore related to maintaining security while providing redundancy within a computing device.

The present invention further provides confirmation of identity—that the network device is a trusted party. For example, two network devices don't need a system administrator to install network link encryption keys—they can set up an encrypted link between themselves using an automated key exchange. The Network Owner installs Network Owner Data, tied to the specific chassis and stored on the TPM's that the network devices can share to confirm that they are trusted parties, that the devices can be interchanged and that information may be passed between them. To extend the example, for a particular switch, the manufacturer's invoice may state that the network device having serial number XYZ, will be physically located in the state of California. This is trackable information. The Network Owner can verify remotely that the devices are those that the Network Owner purchased and can therefore use this information to install the Network Owner Data in confidence, thus adding the new device to the club of trusted hardware on the Owner's network.

For the case where the identity data storage module fails, the management module software will recognize: (1) when a new identity data storage module is inserted, and (2) when the identity data storage module contains either no Network Owner Data or alternatively that the identity data storage module contains Network Owner Data from another switch. In this case where the identity data storage module contains Network Owner Data from another switch, the management module will delete any incorrect Network Owner Data from the identity data storage module and replace it with the current and correct Network Owner Data.

Presence of at least one management module (or module which has a CPU in combination with the TPM) is required to perform the security functions described that are consistent with the described invention. The identity data storage modules and management modules are removable and can be moved in and out of the switch chassis. However, there are rules of priority that control Network Owner Data migration upon insertion of modules.

The rules of operation are based upon chassis origin and reliability—whatever is considered to be the most reliable data in the chassis is given precedence. What is considered to be the most reliable data depends on whether the system is already running or whether the system is booting up. There are three cases to consider:

1. The switch has never had Network Owner Data installed, as would be the case when the switch is delivered from the factory.

2. The switch has had Network Owner Data installed and is running. In this case, failure, removal and insertion of modules is allowed and Network Owner Data is managed. So lone, as at least one management module remains running, the Network Owner Data will not be lost.

3. The switch has had Network Owner Data installed but is not currently running. In this case, more care must be used in determining what Network Owner Data is considered reliable.

The following descriptions incorporate the following rules of precedence:

1. Network Owner Data must be for “This” network device. Network Owner Data from another device is never used. (And Network Owner Data is secured against access or use on another computing platform.)

2. Network Owner Data on a running switch will be preserved unless deliberately altered by the Owner/Administrator.

3. Network Owner Data with the highest version count will have precedence over Data with a lower version count.

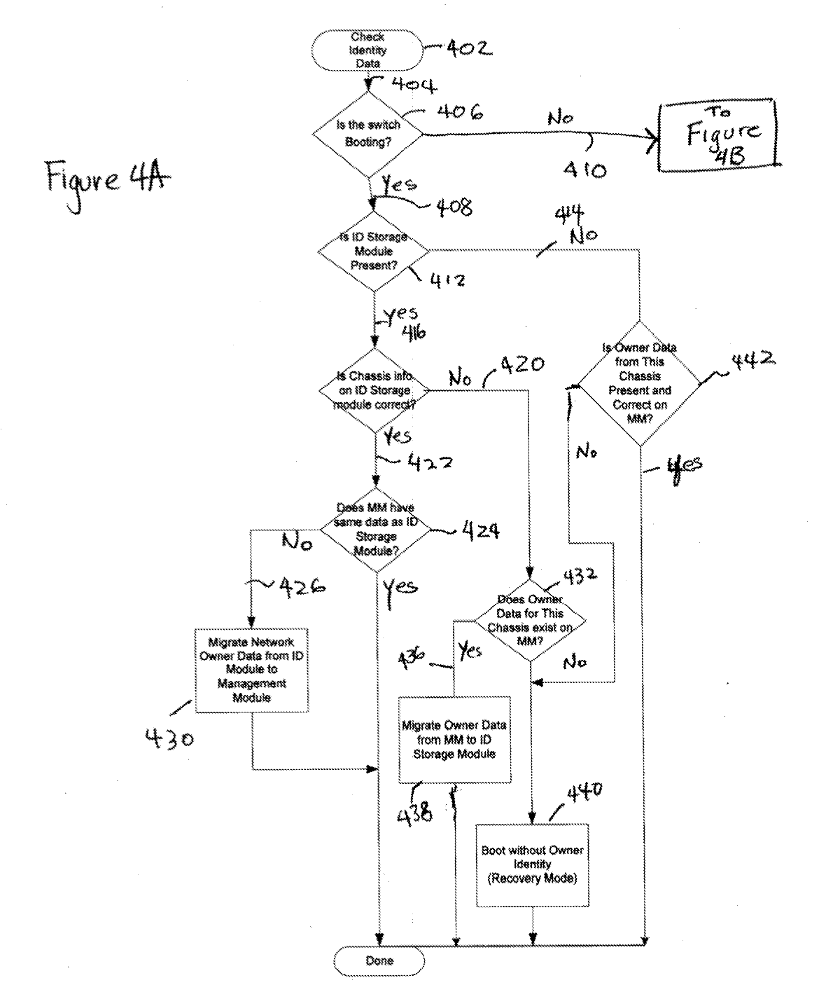

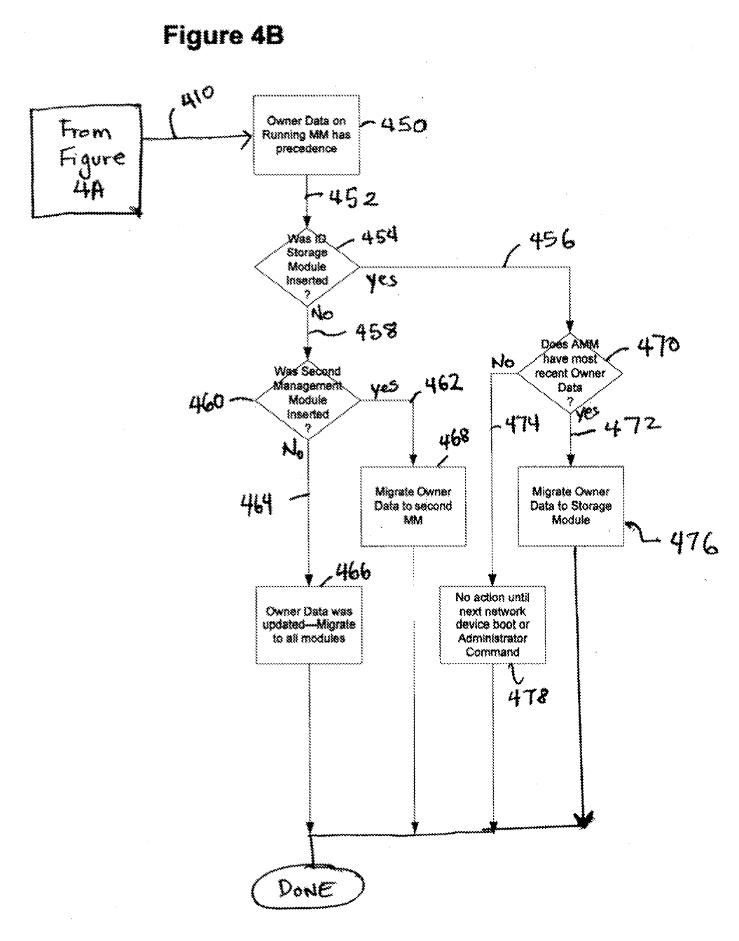

FIG. 4 shows a flowchart of a method of sharing identity information between the identity data storage module 120 and management module 130 in one embodiment of the present invention. Referring to FIG. 4, step 402 begins a process of checking and maintaining consistency of the identity data when booting, when a module has been inserted into the network device or when the network administrator has made a change to the Network User Data.

The process first checks to see if the switch is booting (step 406). If the switch is booting (408), then the switch checks to see if the identity data storage module is present (step 412). If the identity data storage module is present, then the validity of the chassis information stored on the identity data storage module is checked (step 418) by comparing the identity information stored in the identity data storage device with the chassis specific information (serial number, base MAC ID, etc.) stored in the CFD. Note that it is possible, although not likely, that both the identity data on the identity data storage module or on the CFD may be absent or corrupted. In this case, identity data cannot be known with certainty and so the Network Owner Data may not be used.

Referring to the flowchart in FIGS. 4A and 4B, when the identity data on the identity Storage Module has been determined to be incorrect (420), the next step is to check whether the identity data for “This” chassis exists on the management module (step 432).

Since for the case we are currently describing, this is the first time that the switch has been booted up—the identity data has not yet been migrated to the first management module. Thus, the answer to whether the Network Owner Data for the chassis exists on the management module the answer is no (434). Since the data has not yet been migrated, the device can only boot without the identity data (to a recovery or “configuration required” mode.) When we booting without the identity data (recovery mode), any switch feature that depends upon the identity data being available will be disabled. Looking at the decision (step 432) as to whether the identity data exists for “This” chassis for the case where the switch has already booted before, the identity data has already been migrated to the management module and thus identity data already exists for the chassis in the management module (436). For this case (436), where the identity data on the identity data storage module is invalid and the identity data on the management is valid, identity data is migrated from the management module to the identity data storage module (step 438).

For the case where the switch is booting (408), the identity data storage module is present (412), and the chassis information on the identity data storage module is validated by comparision with data on the CFD (422), the switch is next checked to see if the identity data in the management module is identical to the identity data stored in the identity data storage module (step 424). If the data is identical (428), no further action is needed (428). This occurs when the switch has already booted before and both the identity data storage module and the management module both have valid and identical identity data stored on their TPMs. For the case where the identity data is not the same (426), then identity data from the identity data storage module is migrated to the affected management module(s) (step 430). This occurs when the switch is being booted up after one or both management modules have been replaced, when both the identity data storage module and management modules are present in the chassis and the CFD validates that the identity data stored on the identity data storage module is correct.

For the case where the switch is booting, but the identity data storage module is not present (414), the switch checks to see if the identity data on the management module is from “This” chassis and valid (step 442). This check is performed by comparing the identity data on the management module with the CFD data. If the data is valid, the correct identity data is already stored on the management module so no further action is needed (446). If however, the identity data on the management module is not from “This” chassis or is not valid, then a boot (recovery mode) occurs where any switch feature that depends on the identity data is disabled.

If the switch is not booting (410), then the switch is running and the identity data on the running management module has precedence (450). The switch is checked to verify whether an identity data storage module was just inserted into the chassis (step 454). Note, that the term “inserted” as used in this case does not mean present. The event to be tested here is an insertion event. In other words, the module was not present previously but now an identity data storage module was inserted and has therefore become present. If an identity data storage module was not inserted in the switch (458), the switch is next checked to see whether a second management module was inserted into the switch (step 460). If a second management module has not been inserted (464), then (since reasons for entering the process have been exhausted) the network administrator has updated identity data and the identity data is migrated to all installed modules (step 466).

TPMs have a counter in them. The TPM counter only increases and the counter value is maintained by the TPM across power cycles (whether the module powers up or powers down). The described invention makes use of this characteristic of the TPM counter. For example, we can check the TPM counter relationships to determine which identity data is the most recent. Determining which module has the most recent identity data is done by checking the TPM counter. Since the TPM counter only increases, the data that is associated with the TPM counter that has the highest value is the most recent data.

If the switch is running (410) and the identity data storage module was just inserted (456), then a comparison is made between the newly-installed storage module and the first management module to see which has the most recent identity data (step 470). If the first management module has the most recent identity data (the management module's TPM counter has a higher value than the TPM counters of the other modules), then the identity data is migrated to the identity data storage module (step 476). If the first management module does not have the most recent data (474), then no action is taken until the next network hoot or until a System Administrator command is issued to force an over-ride of the precedence rule (450).

Although the described system would work if the identity data storage module included a CPU, in the preferred embodiment the identity data storage module does not preclude the inclusion of a CPU. Since the CPU is not necessary on the identity data storage module for the storage or communication of the identity information to a management module, it is preferable to not include a CPU since implementation without a CPU is less expensive. If there is no CPU on the identity data storage module, the identity data storage module cannot be used for authentication, this is instead done by the management module. Without a CPU on the identity data storage module, each of the management modules must have direct access to the TPM on the identity storage module.

Although the descriptions are primarily made with reference to a network switch, it is anticipated that the described method and apparatus are applicable to any network device, where a network device may be described as any device found within the network that controls the flow of data in the network. It is anticipated that the term network device would apply to for example, a network switch device, a network router device or a network data storage device.

From the standpoint of the TPM, the User is the network, switch software. Instructions of software described in this application are loaded for execution on a processor. The term CPU or processor includes microprocessors, microcontrollers, processor modules or subsystems (including one or more microprocessors or microcontrollers), or other control or computing devices. A “processor” can refer to a single component or to plural components.

The foregoing description, for purposes of explanation, used specific nomenclature to provide a thorough understanding of the invention. However, it will be apparent to one skilled in the art that specific details are not required to practice the invention. The foregoing descriptions of specific embodiments are presented for purposes of illustration and description. They are not intended to be exhaustive of or to limit the invention to the precise forms disclosed. For example, the network device 100 could be comprised of a: a removable first management module 130a associated with a TPM 132a and a central processing unit 134a, wherein the first management module is installed in the network device the first time the network device is powered up, whereupon when the first network device is powered up for the first time, identity data from the first identity data storage module 120a is migrated to the TPM 132a of the first removable management module 130a, the first removable management module capable of communicating with an identity data storage module 120a, the removable first identity storage module including a TPM 122a and being associated with a first memory storage device 124a, wherein identity data unique to the network device is stored in the first memory storage device, wherein the removable first identity data storage module is installed in the network device 100 the first time the network device is powered up.

Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A network device in a high availability network, comprising:
a removable first identity data storage module, the removable first identity data storage module including a TPM and associated with a first memory storage device, wherein identity data unique to the network device is written into the first memory storage device, wherein the removable first identity data storage module is installed in the network device the first time the network device is powered up; and
a removable first management module, the removable first management module associated with a TPM and a central processing unit, capable of running on only the first chassis, wherein the removable first management module is installed in the network device the first time the network device is powered up, wherein when the first network device is powered up, identity data from the first identity data storage module is migrated to the removable first management module.

2. The network device recited in claim 1 wherein the TPM of the identity data storage module and the TPM of the first management module both have counters, and wherein the TPM counter with the highest value indicates the module which has the most recent identity information unique to the network device.

3. The network device recited in claim 1 wherein the identity information unique to the network device is written into the first memory storage device by the manufacturer of the device.

4. The network device recited in claim 2 further including a removable second management module that is inserted into the device, the removable second management module associated with a TPM and a central processing unit, wherein the TPM of the second management module includes a counter.

5. The network device recited in claim 4, wherein after the network device is running and the TPM counter values are different, the identity information unique to the network device is migrated from the management module that has the highest TPM counter value to any other installed management module that has a lower TPM counter value.

6. The network device recited in claim 1, wherein after the network device has powered up, identity data will be preserved so long at least one management module remains operational in the network device.

7. The network device recited in claim 1, wherein the identity data is not transferable to another network device.

8. A method of sharing migratable data in a network device, including the steps of:
establishing that a first module and a second module are in the same chassis group so that identity information unique to the network device can be shared between a first module having a TPM and a second module having a TPM; and
determining whether identity data unique to the network device should be migrated from a first module to a second module.

9. The method recited in claim 8, wherein the determining step further includes the step of determining whether the network device is booting up.

10. The method recited in claim 9 wherein when the network device is booting up for the first time and the first module is an identity data storage module and the second module is a management module, data is migrated from the identity data storage module to the management module.

11. The method recited in claim 10, wherein the network device is booting up for the first time, wherein the network device further includes a second management module, wherein identity data is migrated from the first identity data storage module to the second management module.

12. The method recited in claim 9, further including the step of determining whether the network device is running.

13. The method recited in claim 12, wherein when the network device is running, the identity data on the network device is preserved unless deliberately altered by a system administrator.

14. The method recited in claim 12, wherein when the network device is running, further including the step of comparing the TPM counter of the first module to the TPM counter of the second module to determine which module has the more recent data.

15. The method recited in claim 14, wherein if the identity data for one module is more recent than in the other module, data is migrated from the module which has the most recent data to the other module.

16. The method recited in claim 9, further including the step of determining if the identity information stored first module is valid, wherein the first module is an identity data storage module and the second module is a management module.

17. A method of defining a chassis group, where enrollment in the chassis group is defined at manufacture:
defining an identity for the chassis, the identity including identity information unique to the chassis, stored in a first memory storage device that is associated with an first identity data storage module, the first identity data storage module associated with a TPM, wherein the identity information is defined by and stored by the manufacturer of the chassis before shipment.
